(19) United States
(12) Patent Application Publication
(10) Pub. No.: US 2019/0126543 A1
(43) Pub. Date: May 2, 2019

(54) POWDER LEVELING IN ADDITIVE MANUFACTURING

(71) Applicant: HEWLETT PACKARD DEVELOPMENT COMPANY, L.P., Houston, TX (US)

(72) Inventors: Po-Jen SHIH, Vancouver, WA (US); Carl Ricklef REID, Vancouver, WA (US)

(73) Assignee: HEWLETT PACKARD DEVELOPMENT COMPANY, L.P., Houston, TX (US)

(21) Appl. No.: 16/074,407

(22) PCT Filed: Oct. 11, 2016
(86) PCT No.: PCT/US2016/056463

§ 371 Date: Jul. 31, 2018

(51) Int. Cl. B29C 64/205; B29C 64/153; B29C 64/314; B33Y 30/00; B33Y 10/00; B33Y 40/00

(52) U.S. Cl. CPC B29C 64/205; B29C 64/153; B33Y 40/00; B33Y 30/00; B33Y 10/00; B29C 64/314

(57) ABSTRACT

In one example, a powder leveling subsystem for additive manufacturing. The subsystem includes an agitating tray which is immersible in, and moveably attachable to, a powder trough. The subsystem also includes a flexible member that has a first end portion attached to the agitating tray. The subsystem further includes an induced strain actuator attached to the flexible member adjacent an opposite second end portion of the flexible member. The second end portion is fixedly attachable to the powder trough.

### BACKGROUND

Additive manufacturing systems are increasingly being used to fabricate three-dimensional physical objects for prototyping and/or production purposes. The physical object is constructed layer-by-layer through selective addition of material, rather than by traditional methods such as molding, or subtractive machining where material is removed by cutting or grinding.

### BRIEF DESCRIPTION OF THE DRAWINGS

FIG. 1 is a schematic representation of a powder preparation system usable in an additive manufacturing system in accordance with an example of the present disclosure.

FIGS. 2A through 2C are schematic cross-sectional representation of powder leveling subsystems usable in a powder preparation system in accordance with an example of the present disclosure.

FIG. 3 is a schematic representation of actuating components of a powder leveling subsystem usable in an additive manufacturing system in accordance with an example of the present disclosure.

FIG. 4 is a flowchart according to an example of the present disclosure of a method of method of leveling a surface of a layer of powder in an additive manufacturing system.

FIGS. 5A through 5D are schematic representations of the operation of the method of FIG. 4 in accordance with an example of the present disclosure.

### DETAILED DESCRIPTION

In additive manufacturing systems, a 3D digital representation or 3D model (i.e. the design) of the object to be fabricated may be divided (“sliced”) into a series of thin, adjacent parallel planar slices. The 3D object may then be fabricated layer-by-layer. Each slice of the representation generally corresponds to a layer of the physical object to be fabricated. During fabrication, the next layer is formed on top of the adjacent previous layer. In one example, each layer is about 0.1 millimeter in thickness. Such a fabrication process is often referred to as “additive manufacturing”:

Additive manufacturing systems use a build material as the material from which each layer is fabricated. In one example, the build material is a fine powder (particulate material), such as for example polyamide (nylon). Other build materials may be powders of a different material and/or having a different cohesive strength. In one example, the powder particles are in the range of 5 to 200 microns in size. In one example, the powder particles have an average size of 50 microns. During fabrication of each layer, the regions of the build material which correspond to the location of the object within the corresponding slice, are selectively fused together, while the other regions remain in unfused form. Once the object is completely fabricated, any unfused build material is removed, leaving behind the fabricated 3D object. In some examples, the unfused build material is removed within the additive manufacturing system, while in other examples the unfused build material is removed external to the additive manufacturing system.

In one example, the additive manufacturing system has a build mechanism which uses a laser to selectively fuse the build material layer-by-layer. To do so, the laser is accurately positioned to irradiate the regions of the build material to be fused in each layer. Such a laser-based system with accurate position control for the fusing laser may be costly.

Another example additive manufacturing system has a build mechanism that uses a simpler and less expensive heat source to fuse the build material in each layer, rather than a laser. The build material may be of a light color, which may be white. In one example, the build material is a light-colored powder. A print engine controllably ejects drops of a liquid fusing agent onto the regions of powder which correspond generally to the location of the object cross-section within the corresponding digital slice. The print engine, in an example, uses inkjet printing technology. In various examples, the fusing agent is a dark colored liquid such as for example black pigmented ink, a UV absorbent liquid or ink, and/or other liquid(s). A heat source, such as for example one or more infrared fusing lamps, is then passed over the entire print zone. The regions of the powder on which the fusing agent have been deposited absorb sufficient radiated energy from the heat source to melt the powder in those regions, fusing that powder together and to the previous layer underneath. However, the regions of the powder on which the fusing agent have not been deposited do not absorb sufficient radiated energy to melt the powder. As a result, the portions of the layer on which no fusing agent was deposited remain in unfused powdered form. To fabricate the next layer of the object, another layer of powder is deposited on top of the layer which has just been processed, and the printing and fusing processes are repeated for the next digital slice. This process continues until the object has been completely fabricated.

In such an additive manufacturing system, the 3D object may be built in a build chamber which includes a build bed. The build bed may be, for example, a tray which supports the 3D object during fabrication. Powder layers are iteratively delivered to the build bed, and the slice of the 3D object corresponding to that powder layer is then fabricated from the powder.

The powder for forming each layer of the 3D object is supplied from a powder trough disposed adjacent to the build bed. Powder is deposited in the trough from a dispenser, and subsequently removed from the trough and deposited on the build bed.

It is desirable for the powder layer in the build bed to have a level surface throughout the entire area of the build bed. A level-surface powder layer contributes to the fabrication of 3D parts having high quality—for example, smooth surfaces, no unintended voids, etc. Some additive manufacturing systems might vibrate the build bed after the powder layer has been added in order to self-level the powder layer in the build bed. However, this can be undesirable. For example, such vibrations may cause previously-fabricated slices of a partially-built object to move or shift their location in the build bed. This results in a misalignment of adjacent layers, which can cause the parts to have a stair-step surface. In addition, a partially-built object in the build tray can cause perturbations in the levelness of the surface of a powder layer deposited above the object, resulting in undesirable local variations in the thickness of the fabricated layer of the 3D object.

Some additive manufacturing systems vibrate an interior feature of the powder trough to self-level the powder layer in the trough before powder is removed from the trough and deposited on the build bed. However, in many cases the mechanism which attempts to level the powder in the trough is not satisfactory. One such mechanism has a motor external to the powder trough which drives a screen in the powder trough using an eccentric cam, which in turn drives a drive arm attached to the Screen. In many cases, bearings and bushings are also utilized. The drive arm transfers eccentric motion from the external motor in order to generate vibration. However, asymmetries in the powder level in the trough can be generated due to small perturbations of loads on the drive motor and/or bearings, and/or the drive arm can be a source of localized asymmetry in the uniformity of the powder volume. Asymmetries and/or perturbations in the powder level in the trough can result in related asymmetries and/or perturbations in the level of the powder after it is transferred to the build bed, which in turn can cause defects in the 3D object similar to those noted above. Furthermore, these mechanisms can be mechanically complex, and subject to wear and failure in powder environments.

Referring now to the drawings, there is illustrated an example of a powder leveling subsystem for an additive manufacturing system. The powder leveling subsystem includes a trough to house powder which is deliverable to a build bed of the additive manufacturing system. The powder is usable to form a layer of an object fabricated by the additive manufacturing system. The powder leveling subsystem includes an agitating tray disposed in the powder trough, and an induced strain actuator coupled to the tray. In operation, the actuator vibrates the agitating tray, and the vibrations fluidize the powder in the trough so as to form a level surface of the powder.

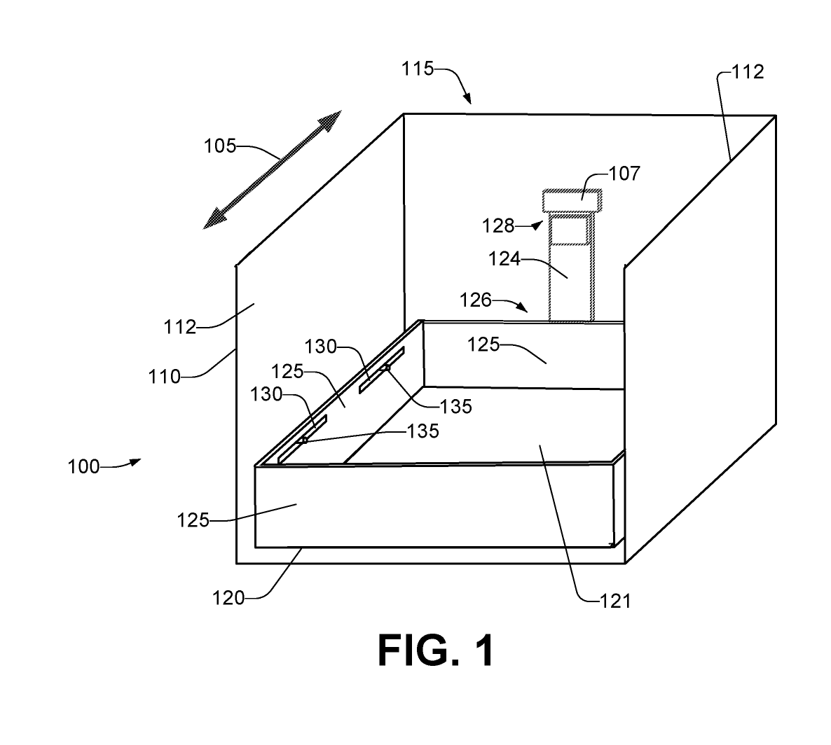

Considering now one example powder preparation system, and with reference to FIG. 1, a powder preparation system 100 includes a powder trough 110. The powder trough 110 has a generally open top surface and is sized for a cavity 115 to hold a certain amount of powder, such as at least the amount of powder to be delivered to a build bed (not shown) to fabricate a layer of a 3D object. The trough 110 may receive a supply of the powder from a powder dispenser (not shown). The trough 110 may be made of any suitable material, and may be shaped to facilitate the delivery of powder from the trough 110 to the build bed. In one example, the trough is substantially rectangular and has an opposing pair of interior walls 112 extending in the longitudinal direction 105. In one example, the trough 110 has a length in the longitudinal direction 105 which is equal to or greater than one dimension of a top surface of a substantially rectangular build bed. The trough 110 is depicted with an end wall removed for clarity of illustration of other elements of the system 100.

The powder trough 110, and/or at least some portions of the powder preparation system 100, may be located in a fixed position relative to the build bed, or may be movable relative to the build bed. In an additive manufacturing system in which the build bed is removable, the powder preparation system 100 and/or the powder trough 110 may be removable with the build bed, or may be retained in the additive manufacturing system when the build bed is removed. Also, the powder preparation system 100 and/or the powder trough 110 may be removable and replaceable in the additive manufacturing system; for example, to when changing from one particular powder type to another powder type.

The powder preparation system 100 includes an agitating tray 120. In one example, the tray 120 has a bottom surface 121 and sidewalls 125 extending generally upward from the edges of the bottom surface 121. The tray 120 is movably attached to the trough 110. In one example, slots 130 in the tray 120 engage with pins 135 protruding from walls 112 of the trough 110 to allow the tray 120 to reciprocate within the trough 110 as guided by the slots 130 and pins 135. An induced strain actuator 122 is attached to a flexible member 124. The flexible member 124 is attached at a first end portion 126 to the tray 120. In some examples, the first end portion 126 is attached to one of the sidewalls 125 of the agitating tray 120 by any mechanical, adhesive, or other means sufficient to maintain the attachment of the flexible member 124 to the tray 120 when the actuator 122 is operated. A second, opposite end portion 128 of the flexible member 124 is fixedly mounted to any fixed point within the additive manufacturing system, which is one example is the trough 110. In one example, a clamp 107 attaches the second end portion 128 of the flexible member 124 to the trough 110, although the second end portion 128 can be attached to the trough 110 by any mechanical, adhesive, or other means sufficient to maintain the end 128 in the fixed position when the actuator is operated.

The induced strain actuator 122 deforms when an electrical signal is applied to it. The deformation of the actuator 122 flexes the flexible member 124, which in turn displaces the end portion 128 of the flexible member 124 which is connected to the tray 120, as a result causing the tray 120 to move within the trough 110. By controlling the characteristics of the electrical signal applied to the actuator 122, the tray 120 can be agitated, or vibrated, at a frequency and an amplitude which causes the powder in the trough to fluidize. In one example, the displacement of the tray resulting from the agitation or vibration is between 1 and 1000 micrometers. Once the powder is fluidized, gravity causes the powder in the trough 110 to self-level. As a result of self-leveling, the volume of powder in the trough 110 becomes uniform in the sense that any small representative volume of powder at a given vertical location has the same local statistical particle size and spatial distribution irrespective of its position in the horizontal plane. What constitutes a “level” powder surface may be defined with reference to specifications of the build system of the additive manufacturing system. In one example, the surface of the powder in the trough levels at a height in the trough which is uniform within 10% of the thickness of a new powder layer in the build bed. Leveling the powder in the trough 110 facilitates provision of a powder layer having a substantially level surface in the build bed.

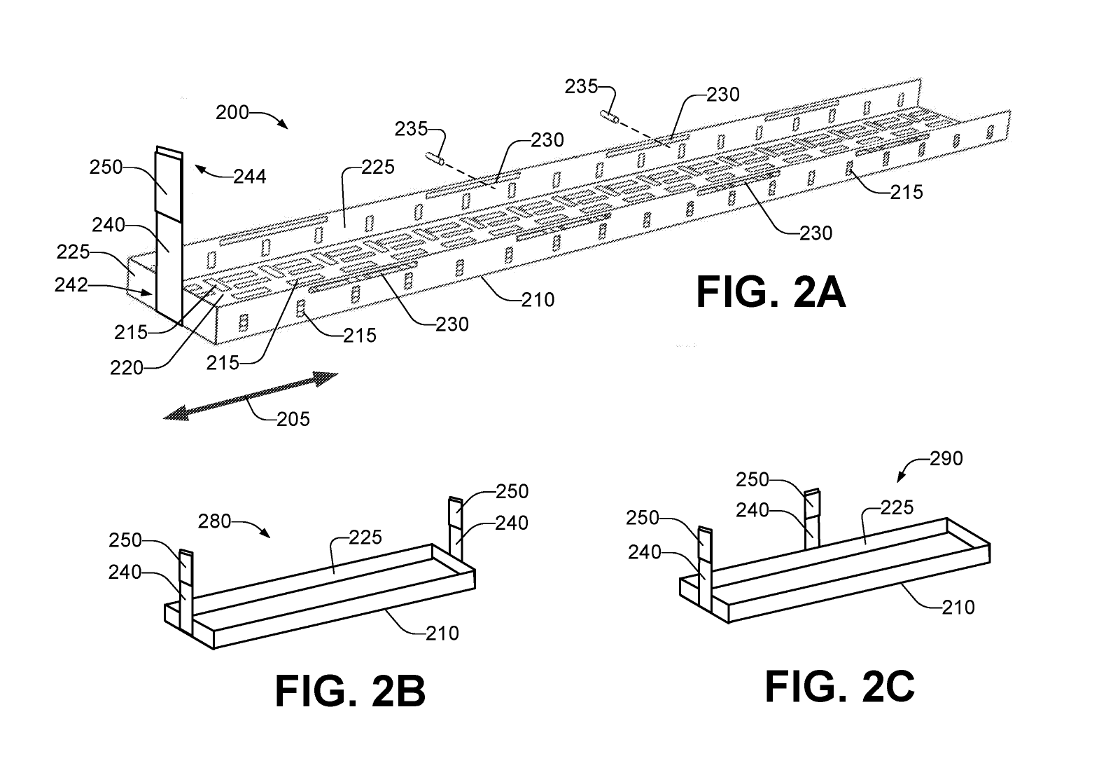

Considering now a powder leveling subsystem, and with reference to FIGS. 2A through 2C, in one example a powder leveling subsystem 200 includes an agitating tray 210, a flexible member 240, and an induced strain actuator 250. In some examples, the subsystem 200 is immersed in a powder trough of an additive manufacturing system. In one example, the powder leveling subsystem 200 includes the agitating tray 120, the sidewall 125, the flexible member 124, and the actuator 122 (FIG. 1).

With reference to FIG. 2A, the agitating tray 210 has a substantially planar bottom surface 220, which may be rectangular, and may have at least one sidewall 225. The sidewall 225 is disposed angularly with respect to the bottom surface 220, in some examples at substantially a right angle to the bottom surface 220. In some examples, the tray 210 has two opposing sidewalls which give the tray 210 a substantially U-shaped cross section. The bottom surface 220 and/or the sidewall 225 may be formed of a stiffer material (i.e. a material having a higher Young's modulus) than the flexible member 240. In one example, the stiffer material is steel.

In some examples, the agitating tray 210 is adapted for movable mounting within a powder trough. In one example, at least one guide slot 230 is formed in at least one sidewall 225. The at least one guide slot 230 mates with a corresponding guide pin 235 disposed on an interior wall of the powder trough, such as for example an interior wall 112 of a trough 110 (FIG. 1). The slot 230 and pin 235 constrain the direction of movement of the tray 210 in response to the actuation of the actuator 250. In one example, at least two slots 230 and pins 235 on opposing sidewalls 225 allow reciprocal movement or vibration of the tray 210 in the longitudinal direction 205. In other examples, different moveable mounting arrangements between the tray 210 and a trough, other than guide slots and pins, may be employed.

The flexible member 240, in some examples, is formed of a more flexible material (i.e. a material having a lower Young's modulus) than the agitating plate 210. In various examples, the more flexible material is copper, aluminum, brass, or other suitable materials. In some examples, the flexible member 240 has a strip-like, substantially planar, flat shape, which may be rectangular. In some examples, the planar surface of a first end portion 242 of the flexible member 240 is attached to a sidewall 225 of the agitating tray 210 by welding, bolting, adhesion, or another attachment method.

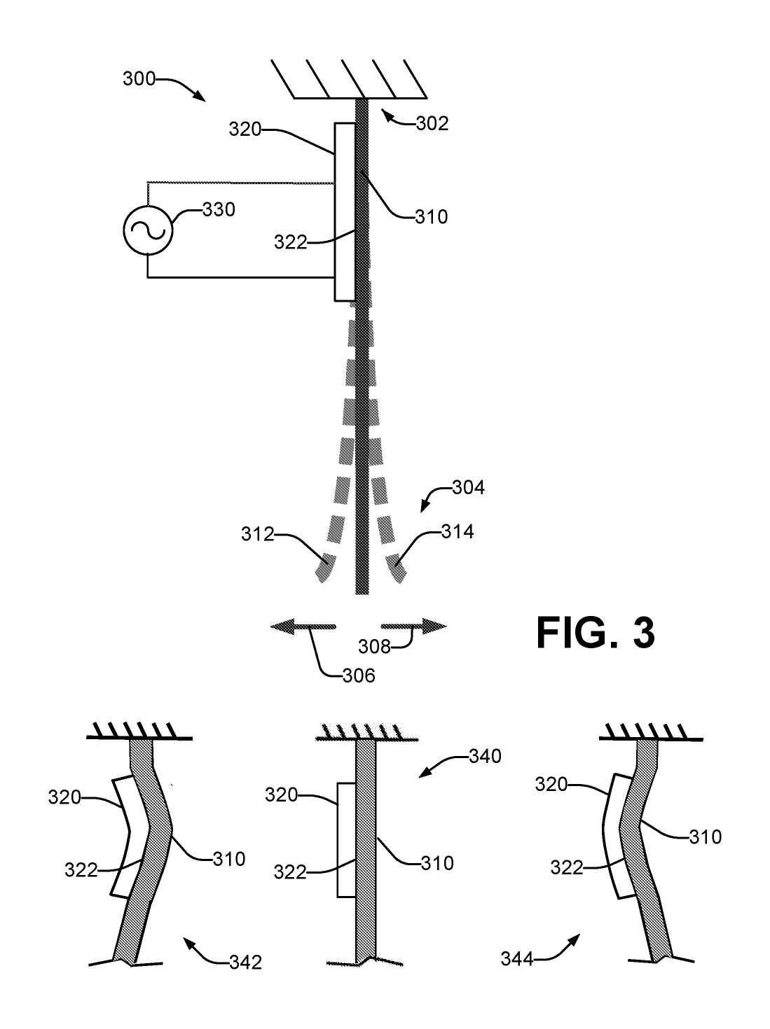

A planar surface of a second end portion 244 of the flexible member 240 opposite the first end portion 242 of the flexible member 240 is fixedly attached to a corresponding planar surface of the induced strain actuator 250. The induced strain actuator 250 is an electromechanical actuator in which an applied electric field causes a change in length of the actuator 250. The material may be, in various examples, an electrostrictive material, a magnetostrictive material, an electro-expansive ceramic, or another type of material. One type of actuator that uses an electro-expansive ceramic, such as for example lead zirconate titanate (PZT), is a piezoelectric actuator. In one example, the actuator 250 is a flextensional piezoelectric actuator. Because one of the planar surfaces of the actuator 250 is fixedly attached to the flexible member 240, the actuator 250 cannot uniformly change length in the plane of the actuator 250 when an electric signal is applied because the length of the flexible member 240 does not change. As a result, the actuator 250 deforms substantially in a direction orthogonal to the plane of the actuator 250, as is discussed subsequently in greater detail with reference to FIG. 3. Where the second end portion 244 of the flexible member 240 is held in a fixed position (such as, for example, where the powder leveling subsystem 200 is installed in a powder trough), the deformation of the actuator 250 deflects the first end portion 242 of the flexible member 240. Because the first end portion 242 is connected to the agitating tray 210, the agitating tray 210 also moves. The movement of the agitating tray 210 may be constrained by the guide slot(s) 230 of the tray 210 and the guide pin(s) 235 provided by a trough. For example, the agitating tray 210 may reciprocate according to the guide slot(s) 230 and the guide pin(s) 235 when an oscillatory electrical signal is applied to the actuator 250 and thus vibrate the tray 210.

Considering the agitating tray 210 further, in some examples, plural apertures 215 are formed in at least one of the bottom surface 220 and/or the at least one sidewall 225 of the agitating tray 210. In one example, the bottom surface is a mesh or a screen. The apertures 215 provide energy to agitate the powder in a trough in which the tray is immersed as the agitating tray 210 is vibrated. The edges of the apertures 215, particularly those which are orthogonal to the direction of movement of the agitating tray 210, transfer the kinetic energy of the vibration to the powder particles as the particles contact those edges. The agitation overcomes the tendency of the powder particles to stick together, which in turn causes the powder to behave as a fluid. Once this occurs, gravity caused the fluidized particles to self-level in the trough. By providing an arrangement or pattern of apertures 215 throughout the entire length of the tray 210, and where the agitating tray 210 spans substantially the entire length of the trough, the agitating force is applied to the powder particles throughout the trough in a substantially uniform manner, thus uniformly fluidizing the powder and leveling substantially all the powder in the trough.

In another example, instead of (or in addition to) the apertures 215, the agitating tray 210 includes fingers (not shown) which protrude above and/or below the planar surface of the tray 210. The vertical sides of the fingers serve the same purpose as the apertures 215—to transfer the kinetic energy of the motion or vibration of the tray 210 to the powder particles as the particle contact the vertical edges of the fingers.

In some examples, a powder leveling subsystem 200 may include more than one pair of flexible member 240 and induced strain actuator 250. With reference to FIG. 2B, a powder leveling subsystem 280 includes two actuator/flexible member pairs. Each pair is disposed at one of the short parallel sidewalls 225 of the tray 210. By applying appropriate signals to the two actuators, the pairs work together synchronously to move the agitating tray 210 in the same direction. This effectively doubles the motive force applied to the agitating tray 210, which may be advantageous when used with a higher-mass tray 210 and/or with a denser powder and/or a higher cohesive strength powder.

With reference to FIG. 2C, a powder leveling subsystem 290 again includes two actuator/flexible member pairs, but in this case the two pairs are disposed at orthogonal sidewalls 225 rather than parallel sidewalls 225. Assuming that the guide slot(s) 230 and the guide pin(s) 235 allow a certain amount of movement in the transverse direction which is orthogonal to the longitudinal direction 205, electrical signals can be applied to the two actuators 250 in a pattern which causes the tray 210 to move in the longitudinal direction 205 and the transverse direction, sequentially or simultaneously. In one example, the electrical signal can be applied to each of the two actuators 250 at a different time. In other examples, a different movable mounting scheme for the agitating tray 210 from the slots 230 and pins 235 may be employed in order to provide more freedom of movement of the tray 210 within the trough.

In yet other examples, more than one actuator/flexible member pair may be mounted to a same sidewall, which also can increase the motive force.

Considering now a schematic representation of actuating components of a powder leveling subsystem, and with reference to FIGS. 3A and 3B, example actuating components 300 includes a flexible member 310, an induced strain actuator 320, and an electrical signal generator 330.

A fixed end portion 302 of the flexible member 310 has a fixed position. For example, the end portion 302 may be fixedly attached to a support surface, such as for example a trough of a powder preparation system. An opposite displaceable end portion 304 of the flexible member 310 is moveable, and may be attached to a movable element of the powder leveling subsystem, such as for example an agitating tray (not shown).

One planar side surface of the flexible member 310 is mounted to a corresponding planar surface 322 of the actuator 320 in a fixed manner. The signal generator 330 is electrically coupled to electrical inputs of the actuator 320. The signal generator 330, which may include an amplifier, is capable of generating and providing to the actuator 320 an electrical signal of a sufficient voltage amplitude to operate the actuator 320. The electrical signal may be an oscillatory signal at a frequency, or range of frequencies, usable to reciprocate or vibrate the displaceable end portion 304 and any movable element attached to the displaceable end portion 304. The oscillatory signal may employ any waveform usable to drive the actuator such as, for example, a sine wave, a square wave, a triangle wave, among others. In one example, the frequency range is between 10 kilohertz and 1000 kilohertz. The particular frequency may be based on the average particle size of the powder, the particle size distribution, the cohesion between powder particles, and/or other factors.

The electric potential applied to the actuator 320 by the signal generator 330 causes the actuator 320 to deform, rather than change length, because the planar surface 322 is fixedly attached to the flexible member 310, as has been discussed heretofore with reference to FIG. 2. A depiction 340 shows the actuator 320 in an unactivated state, with no deformation of the actuator 320. Another depiction 342 shows the actuator 320 in a first activated state in which the actuator 320 is deformed with the surface 322 bulging in an outward direction (i.e. the surface 322 becomes convex). A further depiction 344 shows the actuator 320 in another activated state in which the actuator 320 is deformed with the surface 322 caving inward (i.e. the surface 322 becomes concave). In some examples, applying an electric field of a first polarity deforms the actuator 320 as in depiction 342, while applying an electric field of a second polarity opposite to the first polarity deforms the actuator as in depiction 344.

Due to the attachment of the actuator surface 322 to the corresponding surface of the flexible member 310, the flexible member 310 is deformed in the same manner as the actuator 320. Because the fixed end portion 302 cannot move, the displaceable end 304 moves. This movement has a component in the direction orthogonal to the plane of the flexible member 310. If the actuator surface 322 bulges outward as in depiction 342, the flexible member 310 is deformed to a shape 312, and the displaceable end portion 304 of the flexible member 310 moves in the direction 306. If the actuator surface 322 caves inward as in depiction 344, the flexible member 319 is deformed to a shape 314, and the displaceable end portion 304 of the flexible member 310 moves in the direction 308.

By applying an appropriate electrical signal from the signal generator 330 to the actuator 320, the displaceable end 304 (and any attached movable element of a powder leveling system, such as an agitating tray) can be displaced by a desired distance, and at a desired frequency. The electrical signal may be applied for a predetermined time. The predetermined time may be a time sufficient to self-level powder in the trough.

In various examples, the electrical signal from a single signal generator 330 may be applied to plural actuators 320; plural actuators 320 may receive an electrical signal from different signal generators 330; and/or additional circuit elements may be disposed between a signal generator 330 and an actuator 320 to deliver the electrical signal from the signal generator 330 to the actuator 320 at a different frequency, amplitude, or phase.

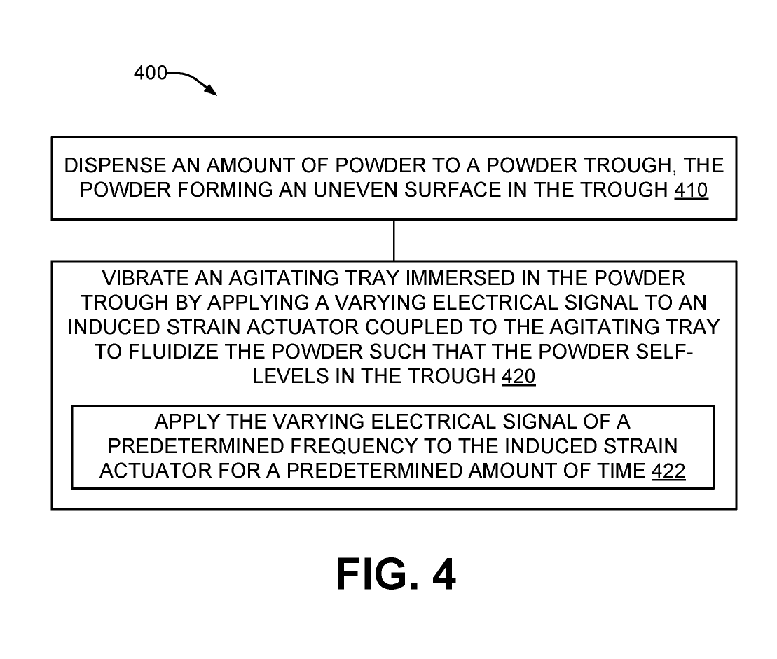

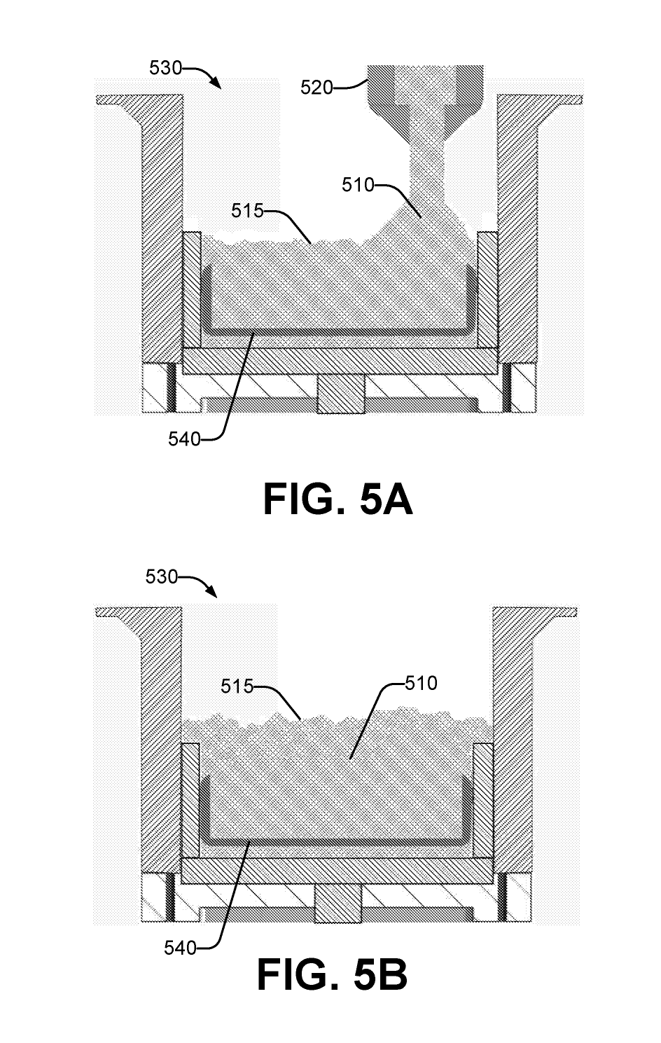

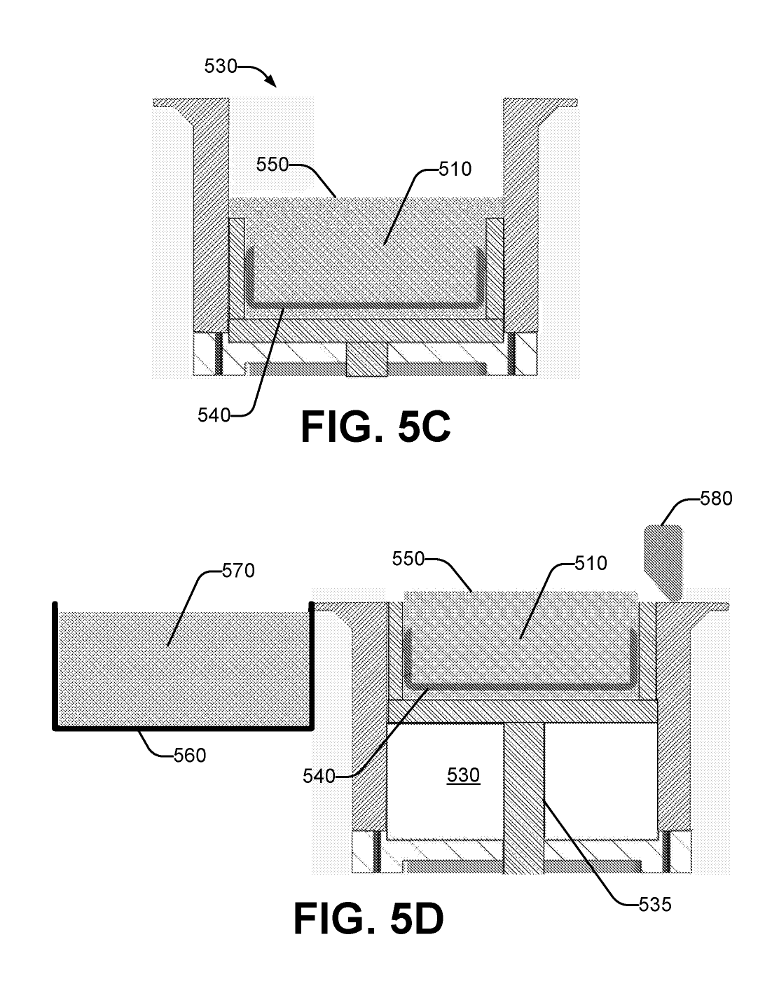

Considering now a method of leveling a surface of a layer of powder in an additive manufacturing system, and with reference to FIGS. 4 and 5A through 5D, a method 400 begins at 410 by dispensing an amount of powder 510 from a powder dispenser 520 to a powder trough 530, as schematically depicted in FIG. 5A. The dispensed powder 510 forms an uneven surface 515 in the trough 530, as schematically depicted in FIG. 5B. At 420, an agitating tray 540 immersed in the powder trough 530 is vibrated. The vibration may be performed by applying a varying electrical signal to an induced strain actuator coupled through a flexible member to the agitating tray 540. In one example, at 422, an electrical signal of a predetermined frequency is applied to the induced strain actuator for a predetermined amount of time. The vibration fluidizes the powder 510 such that the powder 510 self-levels to form a level surface 550 in the trough 530 via gravity, as schematically depicted in FIG. 5C.

After the powder 510 has been leveled, it may be moved to a build bed 560 and deposited on top of previously-deposited powder layers 570 for use in forming the next layer of the 3D object being fabricated. The powder may be moved from the trough 530 to the build bed 560 in a variety of ways. As one example, as schematically depicted in FIG. 5D, the leveled powder 510 may be raised in the trough 530 by a piston 535 until an amount of powder 510 to be used for the next layer extends above the trough 530, and a mechanism 580 may then transport that amount of the leveled powder 510 to the build bed 560. In some examples, the build bed 560 is not agitated or vibrated to level the powder within the build bed 560.

In some examples, at least one block or step discussed herein is automated. In other words, apparatus, systems, and methods occur automatically. As defined herein and in the appended claims, the terms “automated” or “automatically” (and like variations thereof) shall be broadly understood to mean controlled operation of an apparatus, system, and/or process using computers and/or mechanical/electrical devices without the necessity of human intervention, observation, effort and/or decision.

From the foregoing it will be appreciated that the subsystem, tray and method provided by the present disclosure represent a significant advance in the art. Although several specific examples have been described and illustrated, the disclosure is not limited to the specific methods, forms, or arrangements of parts so described and illustrated. This description should be understood to include all combinations of elements described herein, and claims may be presented in this or a later application to any combination of these elements. The foregoing examples are illustrative, and different features or elements may be included in various combinations that may be claimed in this or a later application. Unless otherwise specified, operations of a method claim need not be performed in the order specified. Similarly, blocks in diagrams or numbers should not be construed as operations that proceed in a particular order. Additional blocks/operations may be added, some blocks/operations removed, or the order of the blocks/operations altered and still be within the scope of the disclosed examples. Further, methods or operations discussed within different figures can be added to or exchanged with methods or operations in other figures. Further yet, specific numerical data values (such as specific quantities, numbers, categories, etc.) or other specific information should be interpreted as illustrative for discussing the examples. Such specific information is not provided to limit examples. The disclosure is not limited to the above-described implementations, but instead is defined by the appended claims in light of their full scope of equivalents. Where the claims recite “a” or “a first” element of the equivalent thereof, such claims should be understood to include incorporation of at least one such element, neither requiring nor excluding two or more such elements. Where the claims recite “having”, the term should be understood to mean “comprising”.

What is claimed is:

1. A powder preparation system for additive manufacturing, comprising:
a trough to house powder deliverable to a build bed, the powder usable to form a layer of an object fabricated by the system;
an agitating tray disposed in the powder trough; and
an induced strain actuator coupled to the agitating tray to reciprocate the agitating tray to fluidize any powder in the trough so as to form a level surface of the powder.

2. The system of claim 1, wherein the build bed is not vibrated.

3. The system of claim 1, comprising:
a guide pin on an interior surface of the trough; and
a guide slot in a sidewall of the agitating tray and engaging the guide pins, wherein the agitating tray reciprocates according to the guide pins and guide slots to produce the vibrations.

4. The system of claim 1, comprising:
a signal generator communicatively coupled to the actuator to provide a varying electrical signal to the actuator to vibrate the agitating tray.

5. The system of claim 4, wherein the varying electrical signal has a predetermined frequency and is applied to the actuator for a predetermined period of time.

6. The system of claim 5, wherein the agitating tray reciprocates in the trough at the predetermined frequency.

7. The system of claim 4, wherein the signal generator provides a first electrical signal to the induced strain actuator, comprising:
a second induced strain actuator coupled to the agitating tray at a different location from the induced strain actuator, wherein a signal generator provides a second electrical signal to the second induced strain actuator.

8. The system of claim 1, wherein the powder has a particle size of between 5 microns and 200 microns.

9. A powder leveling subsystem for additive manufacturing, comprising:
an agitating tray immersible in, and moveably attachable to, a powder trough;
a flexible member having a first end portion attached to the agitating tray at a first location; and
an induced strain actuator attached to the flexible member adjacent an opposite second end portion of the flexible member, the second end portion fixedly attachable to the powder trough.

10. The powder leveling subsystem of claim 9, wherein the actuator is deformable in a direction orthogonal to a planar actuator surface, and wherein the actuator surface is fixedly attached to a planar surface of the flexible member to cause deflection of the first end portion of the flexible member responsive to deformation of the actuator.

11. The powder leveling subsystem of claim 9, wherein, responsive to an oscillatory control signal applied to the actuator, the first end portion of the flexible member reciprocates the agitating plate to fluidize a powder bed in which the tray is immersed so as to level the powder bed.

12. The powder leveling subsystem of claim 9,
wherein the agitating tray has a substantially planar bottom portion, a substantially rectangular shape, and a substantially u-shaped cross-section, and
wherein the first end portion of the flexible member is attached to the agitating tray at a sidewall of the agitating tray.

13. The powder leveling subsystem of claim 9, comprising:
at least one pair comprising a second flexible member and a second induced strain actuator, the second flexible member attached to the agitating tray at a different second location.

14. A method of leveling a surface of a layer of powder in an additive manufacturing system, comprising:
dispensing an amount of powder to a powder trough, the dispensed powder forming an uneven surface in the trough; and
reciprocating an agitating tray immersed in the powder trough by applying a varying electrical signal to an induced strain actuator coupled to the agitating tray to fluidize the powder such that the powder self-levels in the trough.

15. The method of claim 14, comprising:
applying the electrical signal of a predetermined frequency to the induced strain actuator for a predetermined amount of time.
